(19) United States
(12) Patent Application Publication
(10) Pub. No.: US 2011/0075003 A1
(43) Pub. Date: Mar. 31, 2011

(54) SOLID-STATE IMAGING DEVICE AND CAMERA INCLUDING THE SAME

(75) Inventors: Sei SUZUKI, Osaka (JP); Toshifumi HABARA, Osaka (JP)

(73) Assignee: PANASONIC CORPORATION, Osaka (JP)

(21) Appl. No.: 12/892,120

(22) Filed: Sep. 28, 2010

(30) Foreign Application Priority Data
Sep. 30, 2009 (JP) 2009-228817

(51) Int. Cl. H04N 5/335

(52) U.S. Cl. 348/311; 348/E05.091

(57) ABSTRACT

The solid-state imaging device according to the present invention includes: vertical transfer units provided to each column of photoelectric conversion units in rows and columns, and which vertically transfer generated signal charges; a horizontal transfer unit which horizontally transfers signal charges; and a first transfer unit and second transfer unit provided between the vertical transfer units and the horizontal transfer unit. The first transfer unit selectively holds and transfers signal charges from the vertical transfer units to the second transfer unit to mix signal charges of m same-color photoelectric conversion units nearest each other in horizontal direction, m being an integer not less than two, and the second transfer unit selectively holds and transfers signal charges from the first transfer unit to the horizontal transfer unit to mix signal charges of n same-color photoelectric conversion units nearest each other in the horizontal direction, n being an integer greater than m.

### BACKGROUND OF THE INVENTION

(1) Field of the Invention

The present invention relates to solid-state imaging devices, and particularly relates to a configuration, in a CCD for a digital still camera, for implementing plural output modes which add up a different number of signal charges of horizontally-adjacent same-color pixels to be added.

(2) Description of the Related Art

Among cameras using a Charge Coupled Device (CCD) as a solid-state imaging device for a digital still camera, CCDs having 10 mega pixels or more have become predominant in recent years and, in addition to an imaging mode (hereafter referred to as normal mode) in which all pixels are read independently without adding up the signal charges that have been photoelectrically converted by the respective pixels, a moving picture mode for displaying on a liquid crystal monitor or recording of video and a high-sensitivity mode for still pictures have become necessary functions.

In the moving picture mode or the high-sensitivity mode, the signal charges obtained from pixels are generally added up in the imaging device. By adding up the signal charges, sensitivity output can be increased, and by decreasing the number of signals to be outputted, video having a high frame rate can be implemented.

The moving picture mode implements a 30 frames/second Video Graphics Array (VGA) output (640×480), a 720 p output conforming to the High Definition (HD) output (1280×720), and so on, from the number of pixels (for example 10 mega pixels) that perform outputting for a still picture. The format outputted in the moving picture mode requires the number of pixels to be compressed to almost 1/10 compared to the number of pixels that perform outputting in a still picture, and the signal charges to be added also increase.

Meanwhile, the high-sensitivity mode is mainly used for still pictures and is effective during continuous shooting due to a higher frame rate than in the normal mode. However, when the number of pixels for addition is too large, the frame rate increases but there is also the problem that resolution deteriorates. The 30 frames/second frame rate equivalent to the video output during actual continuous shooting is not required in normal usage, and when used, results in the mechanical shutter being used in the open state since the continuous shooting speed of the mechanical shutter is unable to keep pace. However, since there is a need to suppress smearing in a camera using a CCD, a mechanical shutter is generally used. Therefore, since continuous shooting performance is determined by the mechanical shutter, it is considered that, in the high-sensitivity mode, the 8 frames/second continuous shooting performance being put into practical use in single-lens reflex cameras is sufficient.

Inside a solid-state imaging device, the adding up of signal charges in the vertical direction is performed in respective vertical transfer units or in a horizontal transfer unit, and the adding up of signal charges in the horizontal direction is performed in the horizontal transfer unit. The addition of signal charges in the vertical transfer units is common practice in an interlaced CCD using a complementary-color filter for movies, but for digital still cameras, signals of adjacent, same-color pixels are added up. Pixel addition in the vertical direction is possible in the vertical transfer units by providing vertical transfer electrodes which perform reading from the photoelectric conversion units to the vertical transfer units, and by being creative with the drive timing. However, pixel addition in the horizontal direction requires a function of selectively suppressing the transfer of signal charge between the vertical transfer units and the horizontal transfer unit.

FIG. 13 is a diagram showing a schematic view of a conventional solid-state imaging device. A solid-state imaging device 100 in FIG. 13 includes vertical transfer units 1, a vertical transfer unit 2, photoelectric conversion units 3, a pixel repeating portion 5, and transfer control units 6. Although the transfer control units 6 shall be described later, there are many conventional examples available.

The operation of the solid-state imaging device 100 configured in the above manner shall be described. Initially, Japanese Patent No. 4178621 (Patent Reference 1) shall be used with regard to the transfer control units 6. In Patent Reference 1, the transfer control units 6 are provided in units of the number of repeating pixels in color coding, which is two in the case of the Bayer array.

The transfer control units 6 inhibit the transfer of signal charge from the vertical transfer units 1 to the horizontal transfer unit 2, for every two columns of the number of repeating pixels. Specifically, each of the transfer control units 6 includes a hold electrode 25 (VΦHold) to which a low-level voltage is applied during transfer inhibition and a storage electrode 26 (VStrage) which is biased using a predetermined direct current voltage.

FIG. 14 shows a layout view showing the configuration of the conventional solid-state imaging device, FIG. 15 shows a potential diagram, and FIG. 16 shows a timing chart.

In the line shift period in FIG. 16, the signal charges of a column without a storage electrode 26 and a hold electrode 25 are transferred to the horizontal transfer unit 2, and in a column having a storage electrode 26, the signal charges are held in the vertical transfer unit 1 under the storage electrode 26 according to the storage electrode 26 to which a DC direct current bias is applied and the hold electrode 25 to which a low-level voltage is applied. After vertically transferring two columns (2 bits) worth of the signal charges previously transferred to the horizontal transfer unit 2, a middle-level voltage is applied to the hold electrode 25 and transfer inhibition is released, after which a low-level voltage is applied to the hold electrode 25 so as to transfer signal charges to the horizontal transfer unit 2, and thus implementing horizontal two-pixel addition.

As shown in FIG. 16, by repeating this twice in the horizontal blanking period, a signal for the two lines on which the horizontal two-pixel addition was performed is formed in the horizontal transfer unit 2.

Furthermore, although having a different structure, there is also a technique which allows addition for two horizontally-adjacent same-color pixels, by having a structure in which first phase and second phase transfer electrodes are placed alternately every predetermined number of columns of vertical transfer units (see Japanese Unexamined Patent Application Publication No. 11-234569 (Patent Reference 2) for example).

Furthermore, there is reported a structure which can implement nine-pixel addition in the case where the number of signal charges of horizontally-adjacent same-color pixels to be added up is three and three-pixel addition is performed in the vertical direction (see Japanese Patent No. 3848650 (Patent Reference 3) for example). Specifically, there is an adding method which can implement nine-pixel addition without moiré or aliases, in the case where the structure has a transfer control unit 6 for every three columns, horizontal three-pixel addition is made possible by providing independent transfer electrodes for independently controlling one or all of the three columns, and vertical three-pixel addition is performed. The electrode structure disclosed in Patent Reference 3 is shown in FIG. 17, and a diagram for describing the charge transfer corresponding to such electrode structure is shown in FIG. 18. Moreover, the present reference discloses implementing horizontal m1 (m1 denotes an integer equal to or greater than 2) pixel addition and horizontal m2 (m2 denotes an integer equal to or greater than 2 that is different from m1) pixel addition, and configuring the unit of repetition m (m denotes an integer equal to or greater than 2) of the vertical last stages using a common multiple of m1 and m2 in order to switch modes. Specifically, the present reference discloses adopting 12 as the unit of repetition m for the vertical last stages in order to implement a four-pixel addition mode consisting of vertical two-pixel addition and horizontal two-pixel addition, and a nine-pixel addition mode consisting of vertical three-pixel addition and horizontal three-pixel addition.

### SUMMARY OF THE INVENTION

However, the above-described conventional configuration only indicates a specific implementation method for addition of two horizontally-adjacent same-color pixels or addition of three horizontally adjacent pixels, and a specific structure which combines two-pixel addition and three-pixel addition of horizontally-adjacent same-color pixels.

In recent years, nine-pixel addition which adds up signal charges of three vertically-adjacent same-color pixels and adds up signal charges of three horizontally-adjacent same-color pixels is used heavily in the moving picture mode since aliases such as moiré can be suppressed. However, the nine-pixel addition has the drawback that resolution is not sufficient for the high-sensitivity mode used in still pictures.

Furthermore, in the technique disclosed in Patent Reference 3, since part of the transfer control units provided in units of three columns use a transfer pulse used in the repetition of pixels, there are timings in the horizontal blanking period where, depending on the column, the transfer of signal charges is not in the horizontal transfer unit direction but is backward instead, and thus proving to be an inefficient structure. As a result, the horizontal blanking period becomes long and is thus not suitable for use in speed enhancement. On the other hand, with only the four-pixel addition consisting of vertical two-pixel addition and horizontal two-pixel addition, there is the drawback that the frame rate for video cannot be increased because of the large number of pixels after addition. Furthermore, vertical four-pixel addition and horizontal four-pixel addition, which is double that described above, results in 16-pixel addition and, in a CCD for a digital camera with an average number of pixels, the number of pixels after addition instead becomes too small, and thus there is the drawback of not achieving a format required at a time of subsequent video output, such as the HD format (1280×720 or 1920×1080).

The present invention solves the above-described conventional problems and has as an object to provide a solid-state imaging device that is capable of combining output modes which add up a different number of signal charges of horizontally-adjacent same-color pixels, and transferring signal charges using a small number of transfers.

In order to achieve the aforementioned object, the solid-state imaging device according to the present invention includes: a plurality of photoelectric conversion units arranged in rows and columns and configured to generate signal charges; a plurality of vertical transfer units each of which is provided to a corresponding one of the columns of the photoelectric conversion units and configured to transfer the generated signal charges in a vertical direction; a horizontal transfer unit configured to transfer the signal charges in a horizontal direction; and a first transfer unit and a second transfer unit which are provided between the plurality of vertical transfer units and the horizontal transfer unit, wherein the first transfer unit is configured to selectively hold and transfer the signal charges from the vertical transfer units to the second transfer unit so as to mix signal charges of m of the photoelectric conversion units that are of same color and nearest to each other in the horizontal direction, m being an integer equal to or greater than two, and the second transfer unit is configured to selectively hold and transfer signal charges from the first transfer unit to the horizontal transfer unit so as to mix signal charges of n of the photoelectric conversion units that are of same color and nearest to each other in the horizontal direction, n being an integer greater than m.

According to this configuration, since the first transfer unit and the second transfer unit are provided, m-pixel addition and n-pixel addition can be handled. Furthermore, the second transfer units which support a mode having a large number of pixels to mix, that is, a large number of transfers to the horizontal transfer unit, are placed further in the horizontal transfer unit-side than the first transfer units, and thereby signal charges can be transferred in the least number of steps without prolonging the horizontal blanking period.

Furthermore, m may be an even number and n may be an odd number equal to or greater than 3.

Furthermore, m may be 2 and n may be 3.

Furthermore, each of the vertical transfer units may include: a vertical transfer channel provided to the corresponding one of the columns; and a plurality of vertical transfer electrodes arranged repeatedly, in predetermined sets, above the vertical transfer channel, the first transfer unit may include: a plurality of first transfer channels each of which is formed in the corresponding one of the columns to be continuous with a corresponding one of the vertical transfer channels; and a plurality of first transfer electrodes formed above each of the first transfer channels and arranged in a row direction and a column direction, each of the first transfer electrodes may have a width spanning at least two columns of the first transfer channels, the second transfer unit may include: a plurality of second transfer channels each of which is formed so as to continue from a corresponding one of the first transfer channels in the corresponding one of the columns; and a plurality of second transfer electrodes formed above each of the second transfer channels, and arranged in the row direction and the column direction, and each of the second transfer electrodes may have a width spanning one column of the second transfer channels.

According to this configuration, each of the first transfer electrodes has a width that spans at least two columns, and thus the first transfer units can selectively hold and transfer signal charges in units of two columns, for example, and thus m-pixel addition can be easily realized. Furthermore, since each of the second transfer electrodes has a one-column width, the second transfer units can selectively hold and transfer signal charges on a per column basis, for example, and thus n-pixel addition can be realized easily.

Furthermore, the first transfer unit may include a plurality of first transfer control units arranged in the row direction, and each of the first transfer control units may include at least three of the first transfer electrodes arranged in the column direction, and may be controlled according to a transfer pulse that is different from a transfer pulse applied to an adjacent one of the first transfer control units.

According to this configuration, two adjacent first transfer control units can be controlled independently, and thus m-pixel addition is possible through a simple structure.

Furthermore, the second transfer unit may include a plurality of second transfer control units arranged in the row direction, and each of the second transfer control units may include at least two of the second transfer electrodes arranged in the column direction, and at least two out of three of the second transfer control units arranged consecutively in the row direction may be controlled according to a pulse signal that is different from a drive pulse signal applied to the vertical transfer units.

According to this configuration, signal charge transferred in the downward direction for example is prevented from being inversely transferred to the upward direction in the second transfer units. Therefore, the horizontal blanking period can be shortened.

Furthermore, the first and second transfer control units corresponding to twelve consecutive columns may make up one signal unit, and respective signal units may be controlled according to a same group of control pulse signals.

According to this configuration, two-pixel addition and three-pixel addition, for example, are possible through a simple structure.

Furthermore, a width of the first transfer channels may be greater than a width of the vertical transfer channels.

According to this structure, the amount of saturated signal charge in the first transfer channels can be increased. Therefore, even when the signal charges generated by a plurality of photoelectric conversion units are added up, the signal charges after the addition can be held.

Furthermore, the width of each of the first transfer channels may gradually increase between a corresponding one of the vertical transfer units and one of the first transfer electrodes closest to the vertical transfer unit, the width increasing towards the first transfer electrode.

Furthermore, the plurality of first transfer electrodes included in the first transfer unit may include, for each of the columns, one electrode which selectively accumulates signal charges, and the plurality of second transfer electrodes included in the second transfer unit may include, for each of the columns, one electrode which selectively accumulates signal charges.

Furthermore, The solid-state imaging device may further include an intermediate electrode provided between the vertical transfer units and corresponding ones of the first transfer electrodes closest to the vertical transfer unit, the intermediate electrode being provided above a connection between corresponding ones of the vertical transfer channels and the first transfer channels, wherein at least one of a width and a length of the intermediate electrode may be greater than at least one of a width and a length of the vertical transfer electrodes.

According to this configuration, the vertical transfer channels and the first transfer channels under the intermediate electrode can hold more signal charges than the signal charges held in the vertical transfer channels under the vertical transfer electrodes.

Furthermore, the number of the first transfer electrodes arranged in the column direction in the first transfer unit may be different from the number of the second electrodes arranged in the column direction in the second transfer unit.

Furthermore, the first transfer electrodes and the second transfer electrodes may be formed in a single layer without overlapping each other.

With this structure, the layout of the wires to be connected to each of the first transfer electrodes and second transfer electrodes is simplified.

Furthermore, a solid-state imaging device according to the present invention includes: a plurality of photoelectric conversion units arranged in rows and columns and configured to generate signal charges; a plurality of vertical transfer units each of which is provided to a corresponding one of the columns of the photoelectric conversion units and configured to transfer the generated signal charges in a vertical direction; a horizontal transfer unit configured to transfer the signal charges in a horizontal direction; a selective transfer unit provided in a stage after the vertical transfer units and configured to selectively hold and transfer signal charges; and a final vertical transfer unit provided between the selective transfer unit and the horizontal transfer unit, wherein the selective transfer unit includes signal charge accumulating electrodes to which a first voltage is applied when the transfer of the signal charges is to be stopped, and transfer inhibiting electrodes to which a second voltage of a level lower than the first voltage is applied, the number of the signal charge accumulating electrodes is one per column, the transfer inhibiting electrodes are provided on a side of the selective transfer unit closer to the final vertical transfer unit, the final vertical transfer unit includes a final vertical electrode provided adjacent to a corresponding one of the transfer inhibiting electrodes, and a length of the final vertical electrode in a signal charge transfer direction is shorter than a length of the transfer inhibiting electrodes in the signal charge transfer direction.

According to this structure, the amount of saturated signal charge in the selective transfer unit can be increased. In particular, it is possible to increase the amount of saturated signal charge of the signal charge accumulating electrode immediately preceding the final vertical electrode in the signal charge transfer direction.

Furthermore, a transfer pulse signal may be applied to the final vertical electrode independently of an electrode in a stage ahead of the final vertical electrode.

According to this configuration, compared to the case of applying a transfer pulse signal that is the same as that for any one of the electrodes in a stage ahead of the final vertical electrode, the modulation of the potential of the second transfer inhibiting electrodes due to the influence of surrounding electrodes, which is a cause of the reduction of the amount of signal charge, is suppressed. Furthermore, it is possible to reduce the load of transfer pulse signals and thus the rise and fall of the transfer pulse signals can be made steep.

Furthermore, the signal charge accumulating electrodes, the transfer inhibiting electrodes, and the final vertical electrode may be formed in a single layer without overlapping each other.

According to this configuration, the layout of the wires to be connected to each of the signal charge accumulating electrodes, the transfer inhibiting electrodes, and the final vertical electrodes is simplified.

Furthermore, the camera according to the present invention includes the above-described solid-state imaging device.

The solid-state imaging device according to the present invention is capable of combining output modes which add up a different number of signal charges of horizontally-adjacent same-color pixels, and transferring signal charges using a small number of transfers.

### FURTHER INFORMATION ABOUT TECHNICAL BACKGROUND TO THIS APPLICATION

The disclosure of Japanese Patent Application No. 2009-228817 filed on Sep. 30, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a layout diagram showing a configuration of a solid-state imaging device according to a first embodiment;

FIG. 2A is an explanatory diagram showing the appearance of vertical charge transfer in the vertical direction of an F-column in the case of horizontal two-pixel addition in 12-phase driving;

FIG. 2B is an explanatory diagram showing the appearance of charge transfer in the vertical direction of an S-column;

FIG. 3A is explanatory diagrams showing the appearance of charge transfer, including the transfer in a horizontal transfer unit;

FIG. 3B is an explanatory diagram continuing from FIG. 3A;

FIG. 4A is an explanatory diagram showing the appearance of charge transfer in the vertical direction of an F-column in the case where ΦV11 is the pulse applied to second signal charge accumulating electrodes of a C-column;

FIG. 4B is an explanatory diagram showing the appearance of charge transfer in the vertical direction of an S-column;

FIG. 5A is an explanatory diagram showing the appearance of charge transfer in the vertical direction of an F-column in the case of horizontal two-pixel addition in six-phase driving;

FIG. 5B is an explanatory diagram showing the appearance of charge transfer in the vertical direction of an S-column;

FIG. 6A is an explanatory diagrams showing the appearance of charge transfer in the vertical direction of an F-column in the case where vertical two-pixel addition is performed in the horizontal transfer unit;

FIG. 6B is an explanatory diagram showing the appearance of charge transfer in the vertical direction of an S-column;

FIG. 7 is a layout diagram of another example showing a configuration of the solid-state imaging device according to the first embodiment;

FIG. 8A is an explanatory diagram showing the appearance of charge transfer in the vertical direction up to a transfer control unit, of charges in the case of horizontal three-pixel addition in six-phase driving;

FIG. 8B is an explanatory diagram showing the appearance of charge transfer of a C-column by a second transfer control unit;

FIG. 8C is an explanatory diagram showing the appearance of charge transfer of an R-column by the second transfer control unit;

FIG. 8D is an explanatory diagram showing the appearance of charge transfer of an L-column by the second transfer control unit;

FIG. 9A is explanatory diagrams showing the appearance of charge transfer, including the transfer in the horizontal transfer unit;

FIG. 9B is an explanatory diagram continuing from FIG. 9A;

FIG. 10A is an explanatory diagram showing the appearance of charge transfer in the vertical direction up to the transfer control unit, of charges in the case of horizontal three-pixel addition in six-phase driving, in the case where the pulse applied to the second signal charge accumulating electrodes of a C-column is ΦV11 (or ΦV5);

FIG. 10B is an explanatory diagram showing the appearance of charge transfer of a C-column by a second transfer control unit;

FIG. 10C is an explanatory diagram showing the appearance of charge transfer of an R-column by a second transfer control unit;

FIG. 10D is an explanatory diagram showing the appearance of charge transfer of an L-column by a second transfer control unit;

FIG. 11 is a layout diagram showing a configuration of a solid-state imaging device according to a second embodiment;

FIG. 12 is a layout diagram showing a configuration of a solid-state imaging device according to a third embodiment;

FIG. 13 is an outline diagram showing the configuration of a conventional CCD solid-stage imaging device;

FIG. 14 is a layout diagram showing the configuration of a conventional CCD solid-stage imaging device;

FIG. 15 is a potential diagram showing a cross section of a conventional CCD solid-stage imaging device along an I-I′ line in FIG. 14;

FIG. 16 is timing chart showing the operation of a conventional CCD solid-stage imaging device;

FIG. 17 is a configuration diagram of a conventional CCD solid-stage imaging device; and

FIG. 18 shows a diagram showing the appearance of charge transfer in a conventional CCD solid-stage imaging device and a timing chart showing the operation thereof.

### DESCRIPTION OF THE PREFERRED EMBODIMENT(S)

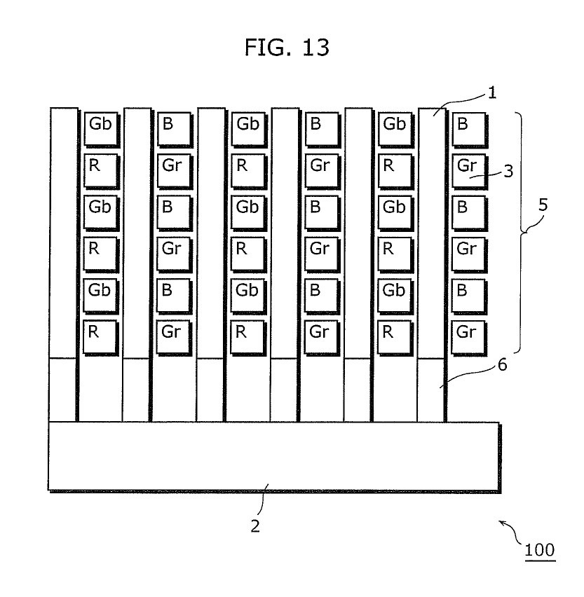

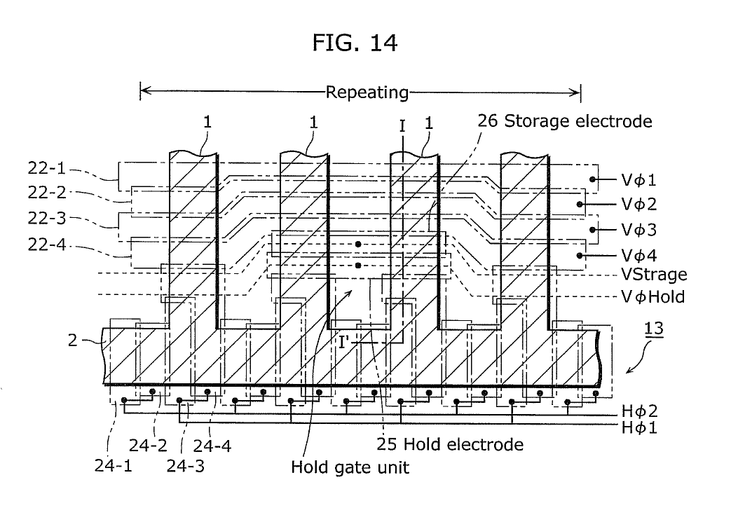

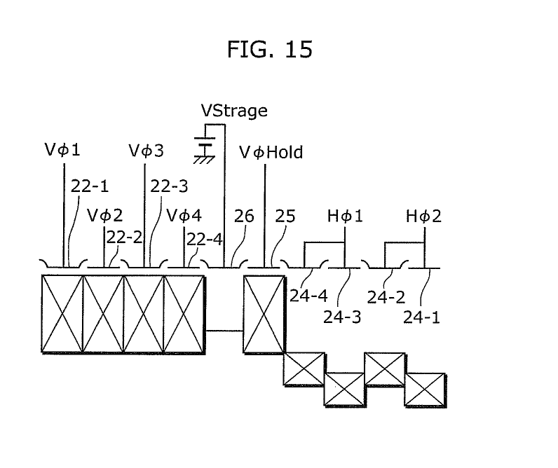

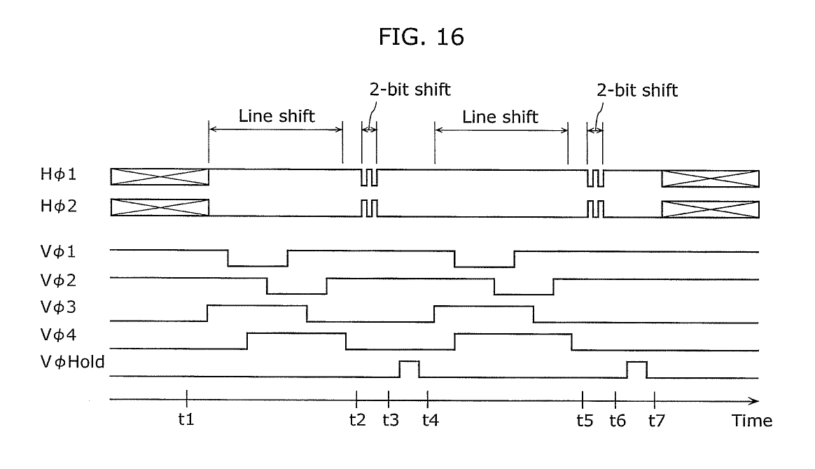

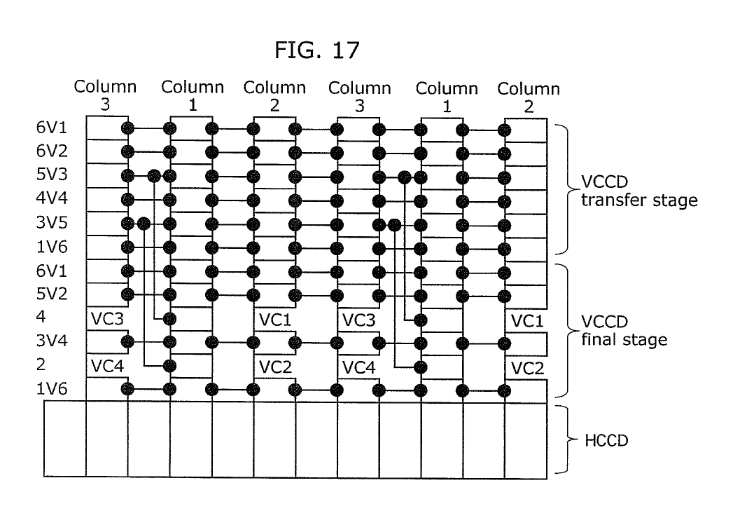

Hereinafter, embodiments of the present invention shall be described with reference to the Drawings. It is to be noted that in the respective embodiments, constituent elements that are identical to those in FIG. 13 shall be assigned the same reference numerals and their description shall be omitted.

### First Embodiment

A solid-state imaging device according to the present invention includes: a plurality of photoelectric conversion units arranged in rows and columns and configured to generate signal charges; a plurality of vertical transfer units each of which is provided to a corresponding one of the columns of the photoelectric conversion units and configured to transfer the generated signal charges in a vertical direction; a horizontal transfer unit configured to transfer the signal charges in a horizontal direction; and a first transfer unit and a second transfer unit which are provided between the plurality of vertical transfer units and the horizontal transfer unit, wherein the first transfer unit is configured to selectively hold and transfer the signal charges from the vertical transfer units to the second transfer unit so as to mix signal charges of two of the photoelectric conversion units that are of same color and nearest to each other in the horizontal direction, and the second transfer unit is configured to selectively hold and transfer signal charges from the first transfer unit to the horizontal transfer unit so as to mix signal charges of three of the photoelectric conversion units that are of same color and nearest to each other in the horizontal direction.

According to this configuration, since the first transfer unit and the second transfer unit are provided, m-pixel addition and n-pixel addition can be handled. Furthermore, the second transfer unit which has a large number of pixels to mix is placed further in the horizontal transfer unit-side than the first transfer unit, and thereby signal charges can be transferred in the least number of steps without prolonging the horizontal blanking period.

Furthermore, each of the vertical transfer units may include: a vertical transfer channel provided to the corresponding one of the columns; and a plurality of vertical transfer electrodes arranged repeatedly, in predetermined sets, above the vertical transfer channel, the first transfer unit may include: a plurality of first transfer channels each of which is formed in the corresponding one of the columns to be continuous with a corresponding one of the vertical transfer channels; and a plurality of first transfer electrodes formed above each of the first transfer channels and arranged in a row direction and a column direction, each of the first transfer electrodes may have a width spanning at least two columns of the first transfer channels, the second transfer unit may include: a plurality of second transfer channels each of which is formed so as to continue from a corresponding one of the first transfer channels in the corresponding one of the columns; and a plurality of second transfer electrodes formed above each of the second transfer channels, and arranged in the row direction and the column direction, and each of the second transfer electrodes may have a width spanning one column of the second transfer channels.

According to this configuration, each of the first transfer electrodes has a width that spans two columns, and thus the first transfer units can selectively hold and transfer signal charges in units of two columns each, and thus two-pixel addition can be performed easily. Furthermore, since each of the second transfer electrodes has a one-column width, the second transfer units can selectively hold and transfer signal charges on a per column basis, for example, and thus three-pixel addition can be realized easily.

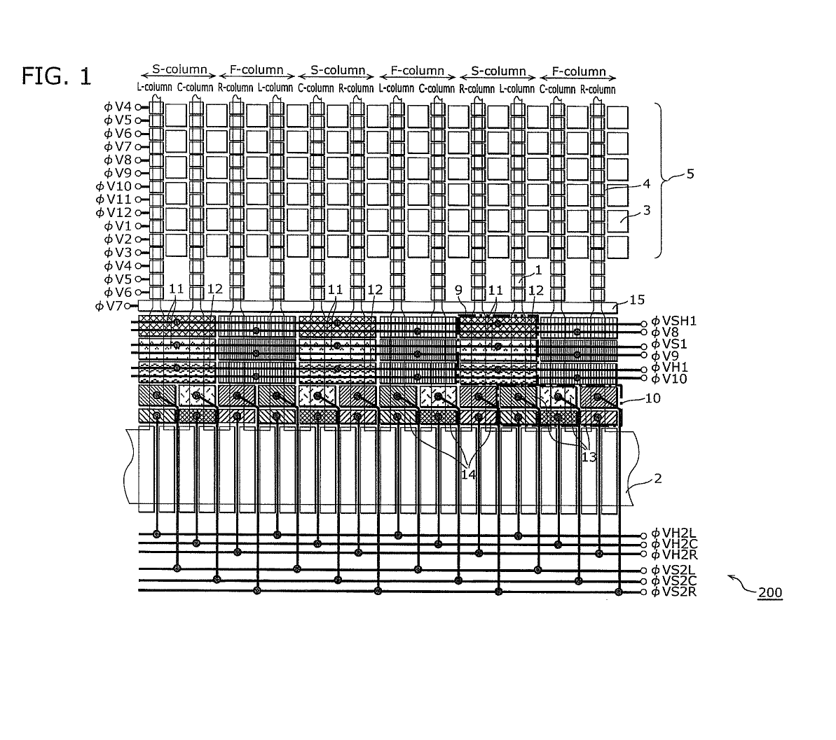

FIG. 1 is a layout diagram showing the configuration of a solid-state imaging device according to a first embodiment of the present invention. A solid-state imaging device 200 in the figure includes the vertical transfer units 1, the vertical transfer unit 2, the photoelectric conversion units 3, vertical transfer electrodes 4, first transfer control units 9, and second transfer control units 10. In the present embodiment, a case of combining horizontal two-pixel addition and horizontal three-pixel addition shall be described.

One of the vertical transfer units 1 is provided to each column of the photoelectric conversion units 3, and each of the vertical transfer units 1 vertically transfers the signal charges generated by the corresponding photoelectric conversion units 3. The vertical transfer unit 1 is, for example, 12-phase driven, and vertically transfers the signal charges generated by the photoelectric conversion units 3 according to driving pulses ΦV1 to ΦV12, and so on. In the vertical transfer unit 1, the part under the vertical transfer electrode 4 functions as a vertical transfer channel, the part under the first transfer control unit 9 functions as a first transfer channel, and the part under the second transfer control unit 10 functions as a second transfer channel.

The first transfer control units 9 support the horizontal two-pixel addition mode, and the second transfer control units 10 support the horizontal three-pixel addition mode. The second transfer control units 10 which support the horizontal three-pixel addition which has a larger number of addition operations are placed on the horizontal transfer unit 2-side.

Specifically, each of the first transfer control units 9 includes first signal charge accumulating electrodes 11 and first transfer inhibiting electrodes 12. The first signal charge accumulating electrodes 11 and the first transfer inhibiting electrodes 12 are provided, as independent electrodes, in units of two columns each with an interval of two columns in between. As transfer pulses, ΦVS1 and ΦVSH1 are applied to the first signal charge accumulating electrodes 11, and ΦVH1 is applied to the first transfer inhibiting electrodes 12. Each of the first signal charge accumulating electrodes 11 to which ΦVSH1 is applied functions either as a transfer inhibiting electrode for forming a potential barrier or a signal charge accumulating electrode for forming a potential well, depending on the drive mode. A transfer pulse that is the same as with the pixel repeating portion 5 is applied to the columns that do not have the first signal charge accumulating electrodes 11 and the first transfer inhibiting electrodes 12. In FIG. 1, columns with the first signal charge accumulating electrodes 11 and the first transfer inhibiting electrodes 12 are denoted as S columns, and columns without them are denoted as F columns. It is to be noted that the first transfer control units 9 included in the solid-state imaging device 200 function as the first transfer unit. Furthermore, the first signal charge accumulating electrodes 11 and the first transfer inhibiting electrodes 12 function as first transfer electrodes.

The second transfer control units 10 are provided between the first transfer control units 9 and the horizontal transfer unit 2, and each of the second transfer control units 10 includes three second signal charge accumulating electrodes 13 and three second transfer inhibiting electrodes 14. The second signal charge accumulating electrodes 13 and the second transfer inhibiting electrodes 14 are provided in units of three columns each, and the second transfer inhibiting electrodes 14 are provided in a stage after the second signal charge accumulating electrodes 13. ΦVS2L, ΦVS2C, and ΦVS2R are applied as transfer pulses to the three second signal charge accumulating electrodes 13, and ΦVH2L, ΦVH2C, and ΦVH2R are applied as transfer pulses to the three second transfer inhibiting electrodes 14. In FIG. 1, in the second transfer control units 10 which are made up of three-column units, a column to which ΦVS2C and ΦVH2C are applied is denoted as a C-column, a column to which ΦVS2R and VH2R are applied is denoted as an R-column, and a column to which ΦVS2L and ΦVH2L are applied is denoted as an L-column. It is to be noted that the second transfer control units 10 included in the solid-state imaging device 200 function as the second transfer unit. Furthermore, the second signal charge accumulating electrodes 13 and the second transfer inhibiting electrodes 14 function as second transfer electrodes. Furthermore, among the three second signal charge accumulating electrodes 13 and the three second transfer inhibiting electrodes 14 provided in each of the second transfer control units 10, the combination formed above the same vertical transfer unit functions as a second transfer control unit.

In this manner, in the solid-state imaging device 200 according to the present embodiment, the first signal charge accumulating electrodes 11, first transfer inhibiting electrodes 12, second signal charge accumulating electrodes 13, and second transfer inhibiting electrodes 14 which correspond to 12 consecutive columns are considered to be one unit, and each of these units are controlled using the same pulse group.

By being combined with vertical two-pixel addition, horizontal two-pixel addition is often used as a four-pixel addition high-sensitivity mode used in a continuous shooting mode using a mechanical shutter. Interlace driving is used in the transfer, from the photoelectric conversion units 3 to the respective vertical transfer units 1, for the vertical two-pixel addition. In recent years, in order to suppress the decrease in the amount of saturated signal charge accompanying the miniaturization of pixels, 6:1 interlace is common in the normal mode, and each of the vertical transfer units 1 has 12 vertical transfer electrodes 4 for six lines. One-stage transfer using 12-phase driving and two-stage transfer of the same color using six-phase driving in a horizontal blanking period are representative methods for driving the pixel repeating portion 5 in the 6:1 interlace.

Here, the expression “one-stage transfer” in a vertical transfer is used to describe the charge transfer for the distance of a vertical transfer unit equivalent to the bank of electrodes corresponding to one unit, where the number of driving phases is considered to be one unit. This means that, in the case of “one-stage transferring using 12-phase driving” and the case of “two-stage transferring using six-phase driving” described above, the method of applying driving pulses in the transfer is different but the effective charge transfer distance of the vertical transfer units are the same for both.

In a mode which performs two-pixel addition in the vertical direction, the signal charges of two pixels in the vertical direction are added up to become one signal in the vertical transfer unit, and the amount of saturated signal charge after such pixel addition is set to the same level as in the normal mode, and thus 3:1 interlace becomes possible and the operation in the charge transfer by the vertical transfer unit becomes the same operation as that in the normal mode.

The operation of the solid-state imaging device 200 configured in the above manner shall be described hereafter. In the description of the operation, the case where the pixel repeating portion 5 is 12-phase driven and the case where it is six-phase driven shall be illustrated.

(Two-Pixel Addition, 12-Phase Driving)

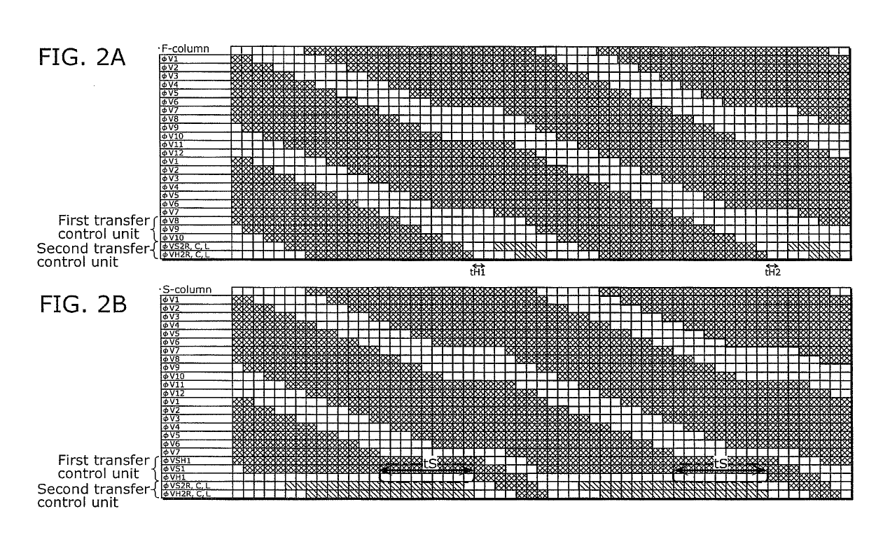

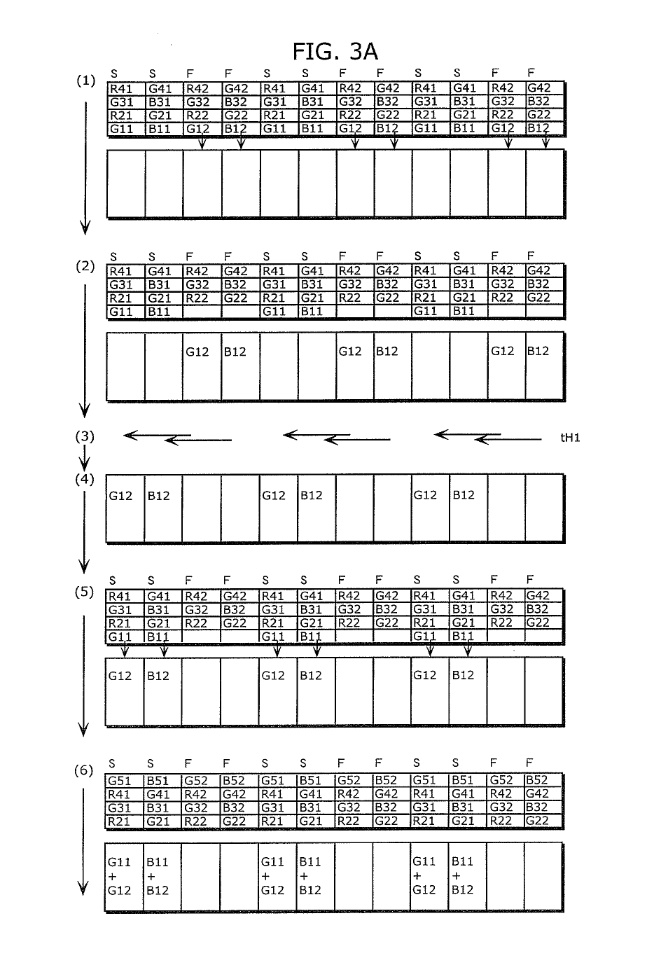

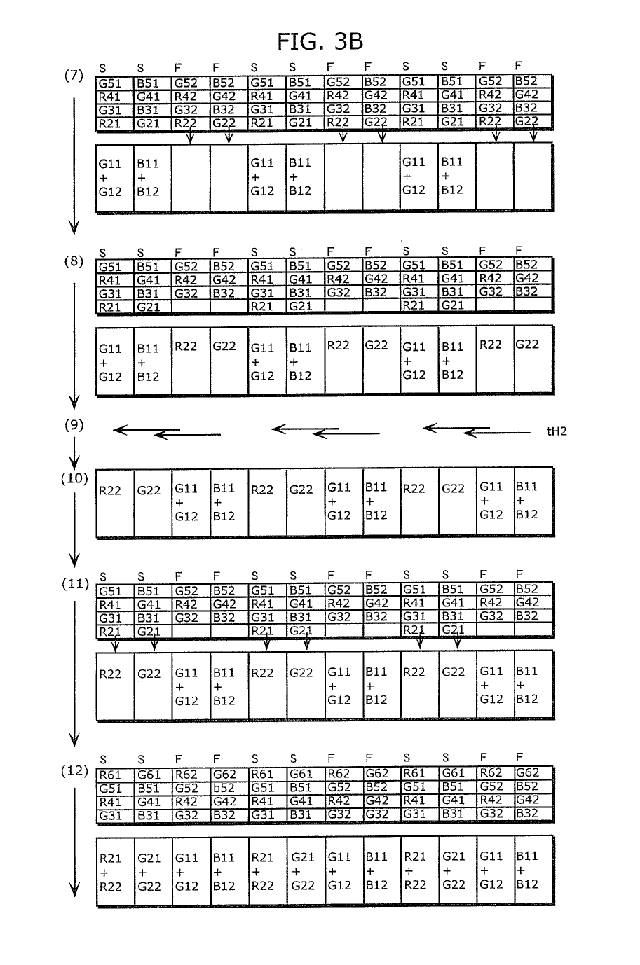

FIG. 2A and FIG. 2B are explanatory diagrams showing the appearance of charge transfer in the vertical direction in the case of horizontal two-pixel addition in 12-phase driving. FIG. 3A and FIG. 3B are explanatory diagrams showing the appearance of the charge transfer in the case of two-pixel addition in 12-phase driving, including the transfer in the horizontal transfer unit 2. It is to be noted that FIG. 2A is an explanatory diagram showing the appearance of the transfer of signal charges of an F-column, and FIG. 2B is an explanatory diagram showing the appearance of the transfer of signal charges of an S-column. Furthermore, FIG. 3B is an explanatory diagram showing the appearance of the transfer continuing from FIG. 3A.

In FIGS. 2A and 2B, the horizontal axis represents time and the vertical axis represents the pulses applied to the respective vertical transfer electrodes 4, the first transfer control units 9, and the second transfer control units 10. The gray part denotes that there is a signal charge in the channel below an electrode to which a corresponding pulse is applied. The slanted-line part denotes that there is no signal charge in the channel below an electrode to which a corresponding pulse is applied. However, in the slanted-line part, the voltage of the electrode to which the corresponding pulse is applied is of a middle level (for example 0V) which allows accumulation of signal charge. The portion excluding the gray part and the slanted-line part denotes that the corresponding pulse is of a low level (for example −6 V), and that there is no signal charge in the channel below the electrode to which the corresponding pulse is applied.

In other words, a potential well is formed under an electrode to which the pulse corresponding to the slanted portion is applied, and a potential barrier is formed under an electrode to which a pulse corresponding to the portion excluding the gray part and the slanted-line part is applied. It is to be noted that the driving of the pixel repeating portion 5 makes use of eight-electrode accumulation which is a method of accumulating signal charges under eight consecutive electrodes at the start and end of vertical transfer.

In 12-phase driving, the signal charges of two vertically adjacent same-color pixels are added up in the vertical transfer unit 1 and the added-up signal charge is transferred to the first transfer control unit 9. In the horizontal two-pixel addition mode, the first transfer control units 9 and the second transfer control units 10 control the transfer of the signal charges from the vertical transfer units 1 to the horizontal transfer unit 2, in units of two columns each. In other words, F-columns and S-columns independently transfer signal charges to the horizontal transfer unit 2.

In the present embodiment, the signal charges of F-columns are transferred to the horizontal transfer unit 2, and the signal charges of S-columns are held in two electrodes to which ΦVSH1 or ΦVS1 is applied, that is, the first signal charge accumulating electrodes 11 (period tS in FIG. 2B, and (1) and (2) in FIG. 3A). At this time, a middle level pulse is applied to the first signal charge accumulating electrodes 11 and a low level pulse is applied to the first transfer inhibiting electrodes 12.

Next, two columns worth of the signal charges of the F-columns that have been transferred first to the horizontal transfer unit 2 are transferred in the horizontal direction (period tH1 in FIG. 2A, and (3) and (4) in FIG. 3A).

Next, by transferring the signal charges of the S-columns to the horizontal transfer unit 2, the signal charges of horizontally adjacent same-color pixels are added up in the horizontal transfer unit 2. It is to be noted that in the present Specification, the terms “line” and “row” are used interchangeably. Here, with regard to the electrodes in the three-column unit in each of the second transfer control units 10, the same drive pulse is applied to all the electrodes located in the same row. By repeating this operation twice ((7) to (11) in FIG. 3B), two lines worth of the signal charges obtained from the horizontal addition are accumulated in the horizontal transfer unit 2 as shown in (12) in FIG. 3B.

It is to be noted that although, in FIG. 2A and FIG. 2B, signal charges are accumulated in a row (ΦVSH1 in FIG. 2B and ΦV8 in FIG. 2A) including the electrode of the respective first transfer control units 9 during the horizontal transfer period excluding the horizontal blanking period, signal charges may also be accumulated in a row that does not include such electrode (for example, electrodes to which ΦV12 and ΦV 1 to 5 are applied).

Furthermore, although the pulse applied to the second signal charge accumulating electrode 13 of a C-column is assumed to be ΦVS2C in the above description, ΦV11 which is applied to the vertical transfer electrode 4 may be applied.

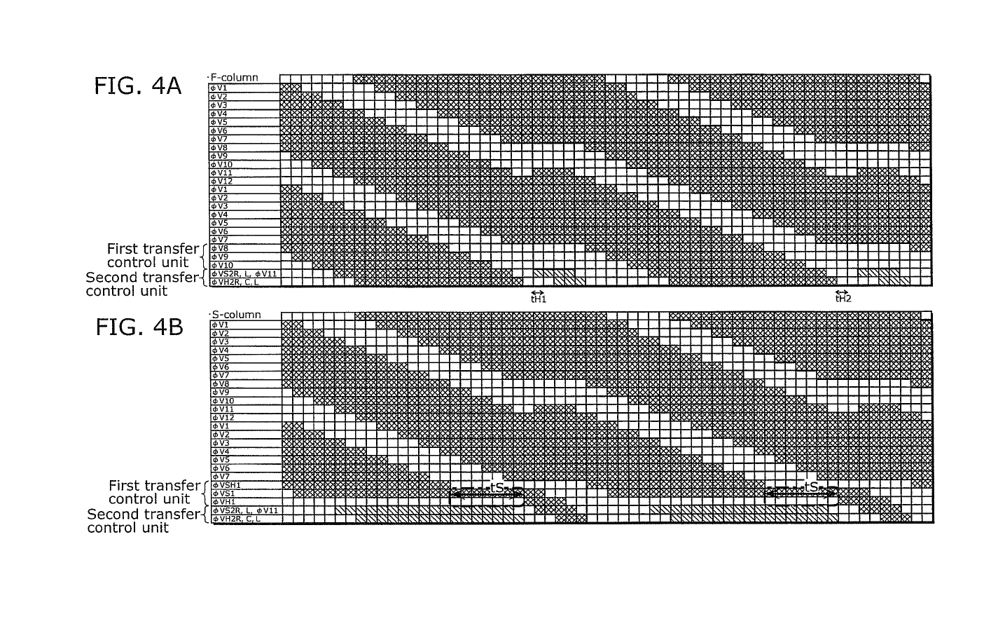

FIG. 4A and FIG. 4B are explanatory diagrams showing the appearance of a transfer in the vertical direction in the case of horizontal two-pixel addition in a horizontal blanking period in the case where the pulse applied to the second signal charge accumulating electrodes 13 of the C-columns is ΦV11, in 12-phase driving and eight-electrode accumulation. The procedure in the horizontal two-pixel addition is the same as that in FIG. 3.

Compared to when ΦVS2C is applied to the second signal charge accumulating electrodes 13 of the C-columns, in the present driving method, after signal charges are transferred to the horizontal transfer unit 2 by F-columns, the signal charges of a subsequent line are accumulated up to an intermediate electrode 15 (the electrode corresponding to ΦV7 in FIG. 4A) adjacent to the first transfer control units 9 (period tH1 in FIG. 4). As such, in each of the first transfer control units 9, the electrode which can hold the signal charges is the one electrode to which ΦVS1 is applied, and the electrode to which ΦVSH1 is applied functions as a transfer inhibiting electrode with respect to the signal charges transferred to the first transfer control unit 9.

It is to be noted that, although an example where the electrode to which ΦVH2C is applied and the electrode to which ΦVS2C is applied are separate in a C-column, it is also acceptable to have one electrode without such separation of electrodes, or such one electrode may be shared with the pulse (for example, ΦV11) applied to the vertical transfer electrodes 4 in the pixel repeating portion 5. In such case, the independent electrodes in each of the second transfer control units 10 can be reduced to the four electrodes to which ΦVS2R, ΦVS2L, ΦVH2R, and ΦVH2L are applied. Stated differently, at least two among the pairs of the second signal charge accumulating electrodes 13 and second transfer inhibiting electrodes 14 included in each of the three second transfer control units 10 lined up consecutively in the row direction are controlled using a pulse that is different from the pulse applied to the vertical transfer electrodes 4.

In addition, as shown in FIG. 4, since the drive timing of ΦVSH1 and ΦV8 belonging to the first transfer control units 9 is the same, ΦVSH1 and ΦV8 can be connected by a wire and shared. In this case, the independent electrodes in each of the first transfer control units 9 can be reduced to the two electrodes to which ΦVS1 and ΦVH1 are applied.

(Two-Pixel Addition, Six-Phase Driving)

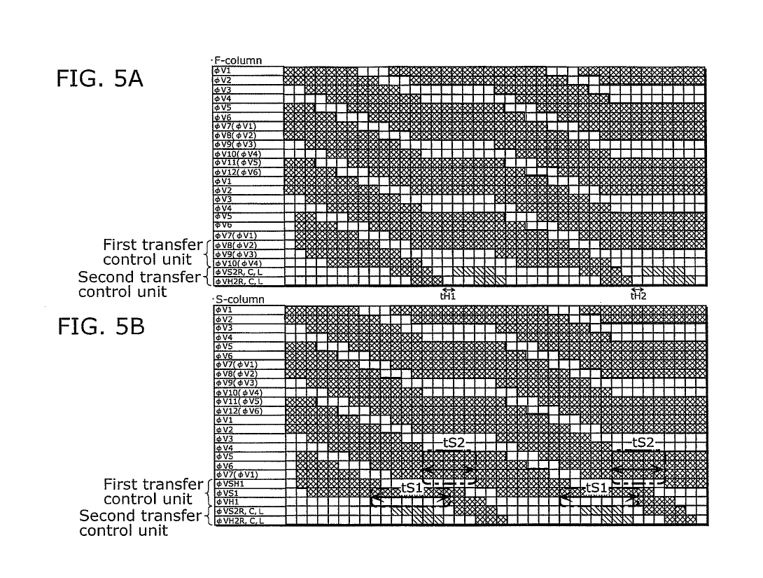

FIG. 5A and FIG. 5B are explanatory diagrams showing the appearance of charge transfer in the vertical direction in the case of horizontal two-pixel addition in six-phase driving. In the present driving method, the driving of the pixel repeating portion 5 makes use of four-pixel accumulation. It is to be noted that although the electrode configuration is matched to that in FIG. 1, ΦV1 and ΦV7, ΦV2 and ΦV8, ΦV3 and ΦV9, ΦV4 and ΦV10, ΦV5 and ΦV11, and ΦV6 and ΦV12 are the same transfer pulses, and the transfer pulse name described in parenthesis “( )” in the figures are transfer pulse names of the same phase. FIG. 5A and FIG. 5B show the case where the signal charges obtained from two-pixel addition in the vertical direction are transferred to the first transfer control units 9 and the second transfer control units 10.

As shown in FIG. 5A, in the F-columns, after the signal charge transfer to the horizontal transfer unit 2, signal charges are accumulated up to the channels under the electrodes to which ΦV8 (ΦV2), which is in the same row as ΦVSH1, is applied (period tH1 in FIG. 5B). As such, in the S-columns, there is a need to apply a low-level voltage as ΦVSH1; the electrode which can hold signal charges is the one electrode to which ΦVS1 is applied; and the first signal charge accumulating electrodes 11 to which ΦVSH1 is applied function as transfer inhibiting electrodes with respect to the signal charges transferred to the first transfer control unit 9, and has a function of suppressing mixing of signal charges between different lines.

It is to be noted that, in the horizontal two-pixel addition in 6-phase driving, a timing for three-electrode accumulation occurs in the period tS2 in FIG. 5B whereas the pixel repeating portion 5 is at four-pixel accumulation, and thus it is preferable that the intermediate electrode 15 (ΦV7 is applied in FIG. 5A and FIG. 5B) adjacent to the first transfer control units 9 has a larger amount of saturated signal charge per electrode than the vertical transfer electrodes 4 of the pixel repeating portion 5. For example, it is sufficient to design the length of the intermediate electrode 15 adjacent to the first transfer control units 9 and the width of the vertical transfer units 1 to be greater than the length and width of the adjacent vertical transfer electrodes 4 in the pixel repeating portion 5.

Furthermore, although vertical two-pixel addition is performed in the vertical transfer units 1 in the above description, it may also be performed in the horizontal transfer unit 2 as in the subsequent example.

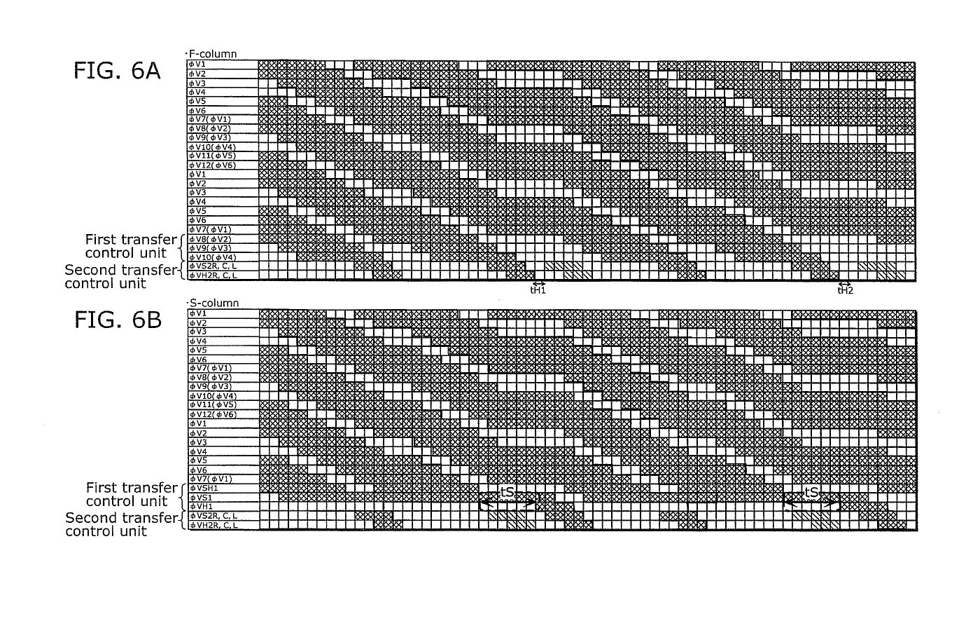

FIG. 6A and FIG. 6B are explanatory diagrams showing the appearance of charge transfer in the vertical direction in the case where vertical two-pixel addition is performed in the horizontal transfer unit 2. As in FIG. 5A and FIG. 5B, although the electrode configuration is matched to that in FIG. 1 in the present figure, ΦV1 and ΦV7, ΦV2 and ΦV8, ΦV3 and ΦV9, ΦV4 and ΦV10, ΦV5 and ΦV11, and ΦV6 and ΦV12 are the same transfer pulses, and transfer pulse names of the same phase are likewise described in parenthesis “( )” in FIGS. 6A and 6B. The present embodiment shows the case where two-pixel addition in the vertical direction is performed in the horizontal transfer unit 2 for F-columns and performed in the first signal charge accumulation electrodes 11 for S-columns. By applying a low-level voltage to ΦVSH1, the first signal charge accumulation electrodes 11 to which ΦVSH1 is applied function as a transfer inhibiting electrodes with respect to the signal charges transferred to the first transfer control units 9 and have a function of suppressing the mixing of signal charges between different lines.

Although the procedure for the horizontal two-pixel addition is the same as that in FIG. 3, in the period during which signal charges are held (period tS in FIG. 6B), signal charges are held in the one electrode to which ΦVS1 is applied. As shown in FIGS. 6A and 6B, since ΦVSH1 and ΦV2, ΦV8 also have the same drive timing in the present example, sharing is possible, and the independent electrodes in the first transfer control units 9 can be reduced to the two electrodes to which ΦVS1 and ΦVH1 are applied.

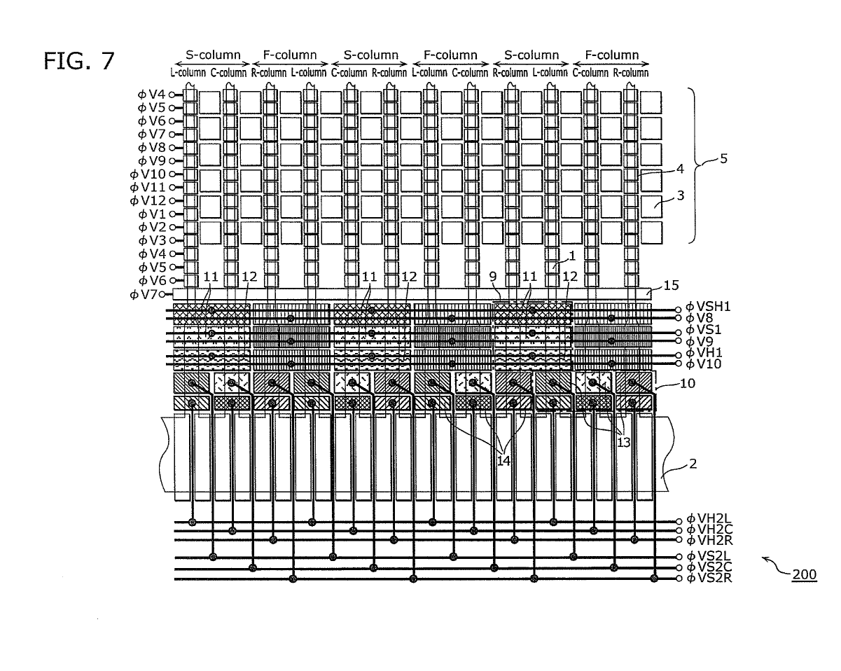

Although a period arises during which signal charges are held in the one electrode to which ΦVS1 is applied in the case where ΦVS2C of the C-column in the second transfer control units 10 in the 12-phase driving and eight-electrode accumulation in FIG. 4A and FIG. 4B is shared with the transfer pulse applied to the vertical transfer electrodes 4 of the pixel repeating portion 5, or in the case of six-phase driving and four-electrode accumulation, in such period, a low-level voltage is applied to ΦVSH1, and thus it is preferable that the potential of ΦVSH1 at this time be the same as that of the pixel repeating portion 5. This is because, when the potential is high, the amount of saturated signal charge decreases due to the weakening of the potential barrier at the horizontal transfer unit 2-side in the location where signal charges are accumulated in the four electrodes (for example, ΦV4 to ΦV7 in FIG. 6B) in the stage ahead of an electrode to which ΦVSH1 is applied, and thus signal charges are sent ahead to the electrode to which ΦVS1 is applied. As such, when the channel under the electrode to which ΦVSH1 is applied is used as a barrier, it is preferable that the position at which the width of the vertical transfer electrodes 1 is to be expanded be more toward the horizontal transfer unit 2-side than the electrode to which ΦVSH1 is applied, that is, the first signal charge accumulating electrode 11 located on the intermediate electrode 15-side, as shown in FIG. 7.

(Three-Pixel Addition, Six-Phase Driving)

Next, the horizontal three-pixel addition mode shall be described.

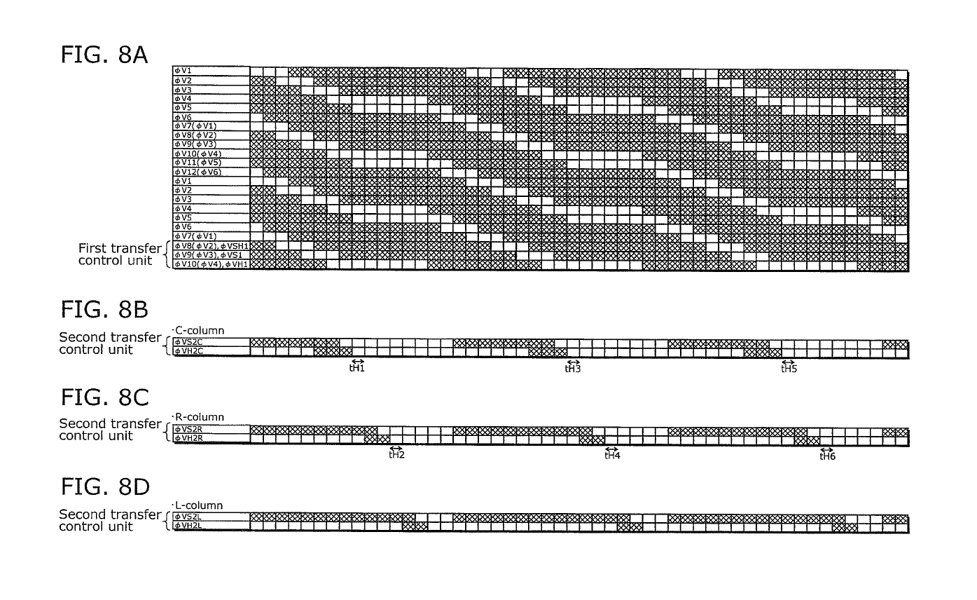

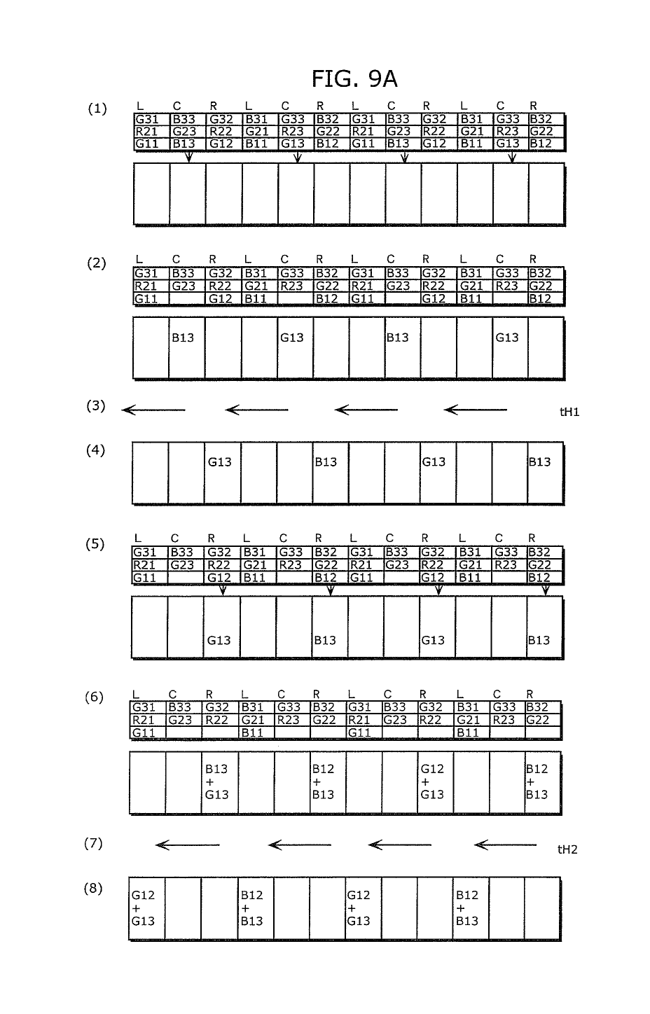

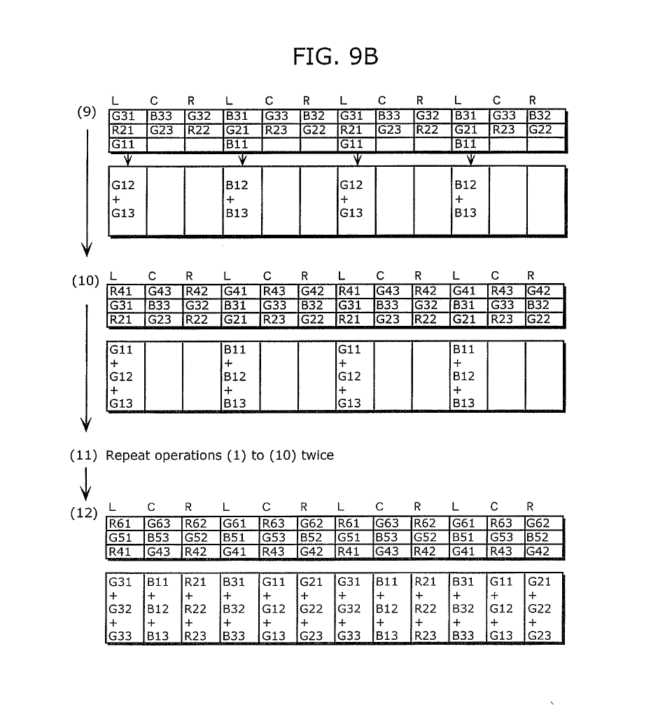

FIG. 8A to FIG. 8D are explanatory diagrams showing the appearance of charge transfer in the vertical direction in the case of horizontal three-pixel addition in six-phase driving. FIG. 9A and FIG. 9B are explanatory diagrams showing the appearance of charge transfer in the case of three-pixel addition in six-phase driving, including the transfer in the horizontal transfer unit 2. It is to be noted that FIG. 8A is a diagram showing the charge transfer up to the first transfer control units 9, FIG. 8B is a diagram showing the charge transfer of the C-column of the second transfer control units 10, FIG. 8C is a diagram showing the charge transfer of the R-column of the second transfer control units 10, and FIG. 8D is a diagram showing the charge transfer of the L-column of the second transfer control units 10. Furthermore, FIG. 9B is an explanatory diagram showing the appearance of the transfer continuing from FIG. 9A.

In the horizontal three-pixel addition mode, after the signal charges of the C-columns are transferred to the horizontal transfer unit 2 ((1) and (2) in FIG. 9A), two-column transfer in the horizontal direction is performed (period tH1 in FIG. 8B, (3) in FIG. 9A).

Next, the signal charges of the R-columns are transferred to the horizontal transfer unit 2 and horizontal two-pixel addition is performed ((5) and (6) in FIG. 9A).

Next, after the completing the transfer, a two-column transfer in the horizontal direction is performed again (period tH2 in FIG. 8C, (7) and (8) in FIG. 9A), and lastly, the signal charges of the L-columns are transferred to the horizontal transfer unit 2 ((9) in FIG. 9B) and horizontal three-pixel addition is performed ((10) in FIG. 9B).

In addition, in the configuration of the solid-state imaging device 200 according to the present embodiment, two-phase driving is assumed for the horizontal transfer unit 2, and by repeating the previous driving three times ((11) in FIG. 9B), signals obtained from the horizontal three-pixel addition of three lines are formed in the horizontal transfer unit 2 ((12) in FIG. 9B).

In other words, the three-pixel addition in the vertical transfer units is performed within the respective vertical transfer units 1 and, combined with the above described horizontal three-pixel addition, realizes a nine-pixel addition operation.

Although a high frame rate is required in the horizontal three-pixel addition mode, in the case where the second transfer control units 10 controlling the horizontal three-pixel addition are located more toward the pixel repeating portion 5-side than the first transfer control units 9, time is required in the transfer of signal charges to the horizontal transfer unit 2 because charge transfer to the horizontal transfer unit 2 is performed via the first transfer control units 9. Since at least two (three in the present embodiment) selective signal charge transfers from the vertical transfer units 1 to the horizontal transfer unit 2 are required in performing horizontal three-pixel addition in the horizontal transfer unit 2, the number of transfer steps increases and the possibility that horizontal blanking will be long arises. However, since the second transfer control units 10 are located towards the horizontal transfer unit 2-side in the present embodiment, transfers are possible with the least number of steps and without prolonging the horizontal blanking period.

Furthermore, from the point of view of reducing the number of transfer steps, the second signal charge accumulating electrodes 13 making up each of the second transfer control units 10 is one electrode. To make this possible, the width of the vertical transfer units 1 under the second signal charge accumulating electrode 13 is set to be greater compared to the pixel repeating portion 5, as shown in FIG. 1 With this, the amount of saturated signal charge of the vertical transfer units 1 under the second signal charge accumulating electrodes 13 can be increased, and thus, even when the signal charges generated from plural photoelectric conversion units 3 are added up, it is possible to secure an amount of saturated signal charge such that charge does not overflow.

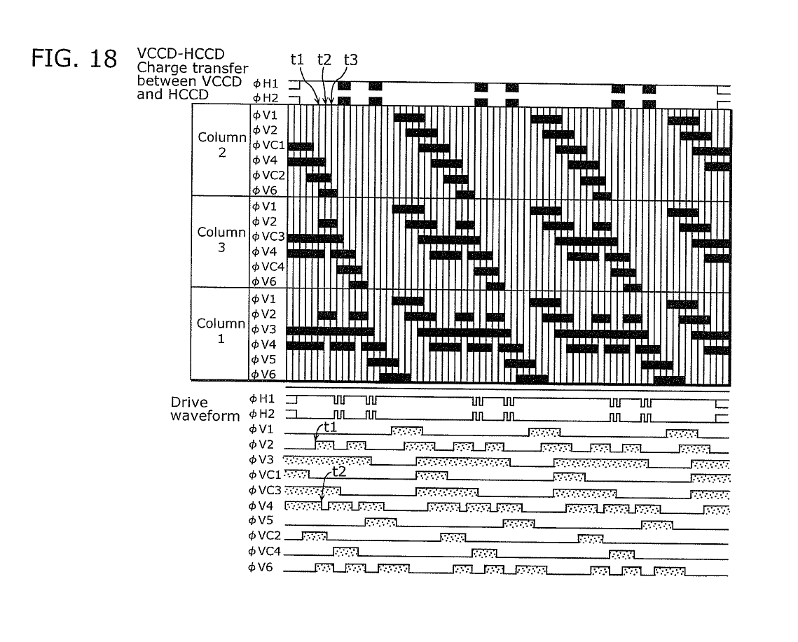

Furthermore, by accumulating signal charges in one electrode, the trouble of the number of transfer steps increasing is remedied, and it becomes possible to perform pixel addition driving efficiently. This means that, by accumulating signal charges in one electrode, inhibiting in one electrode, and applying, to each of such electrodes, a pulse that is independent of that for the pixel repeating portion, the need to perform transfer in the reverse direction as in the conventional example (FIG. 18) is eliminated, and thus the horizontal blanking period can be shortened.

Furthermore, in the C-columns, ΦVH2C may be shared with the pulse (for example, ΦV11) applied to the vertical transfer electrodes 4 in the pixel repeating portion 5. Stated differently, the pulse applied to the second signal charge accumulating electrodes 13 in the C-columns may be ΦV11.

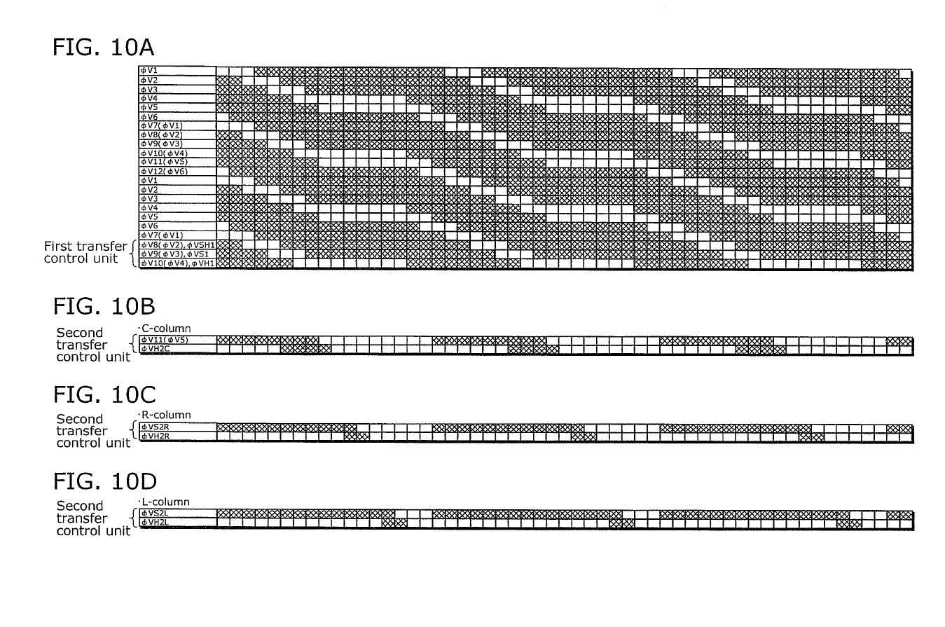

FIG. 10A to FIG. 10D are explanatory diagrams showing the appearance of transfer in the vertical direction in the case of horizontal three-pixel addition in a horizontal blanking period in the case where the pulse applied to the second signal charge accumulating electrodes 13 of the C-columns is ΦV11 (or ΦV5), in six-phase driving and four-electrode accumulation. The procedure in the horizontal three-pixel addition is the same as that in FIG. 9A and FIG. 9B.

In this case, the independent electrodes in the second transfer control units 10 can be reduced to the five electrodes to which ΦVS2R, ΦVS2L, ΦVH2R, ΦVH2L, and ΦVH2C are applied.

Furthermore, the second transfer control units 10 have an electrode configuration that is in units of three columns each, and thus unit electrodes are closer compared to those in the first transfer control units 9 which are configured in two-column units. Thus, by being located in the horizontal transfer unit 2-side, wires can also be placed on the horizontal transfer unit 2-side, and thus the second transfer control units 10 have the remarkable feature of facilitating wiring layout.

It is to be noted that, as with the present embodiment, when electrodes to which different transfer pulses are applied come close to each other, a configuration with two layers of electrodes makes wiring layout difficult due to overlapping between electrodes, and thus it is preferable to have a single layer configuration for the electrodes.

In this manner, the solid-state imaging device 200 according to the present embodiment realizes a solid-state imaging apparatus that (i) allows switching among operating modes having different numbers of pixel addition in the horizontal direction by having transfer control units corresponding to the operating modes, and (ii) can reduce the number of transfer steps during moving-picture mode and perform the horizontal addition operations in a short time by placing, on the horizontal transfer unit-side, the transfer control unit corresponding to the moving-picture mode having a large number of pixels to be added.

### Second Embodiment

Compared to the solid-state imaging device 200 according to the first embodiment, in a solid-state imaging device according to a second embodiment, the electrodes of the first signal charge accumulating electrodes included in the first transfer control units 9 are formed to be large in the transfer direction and thereby increasing the amount of saturated signal charge in the first transfer control units 9.

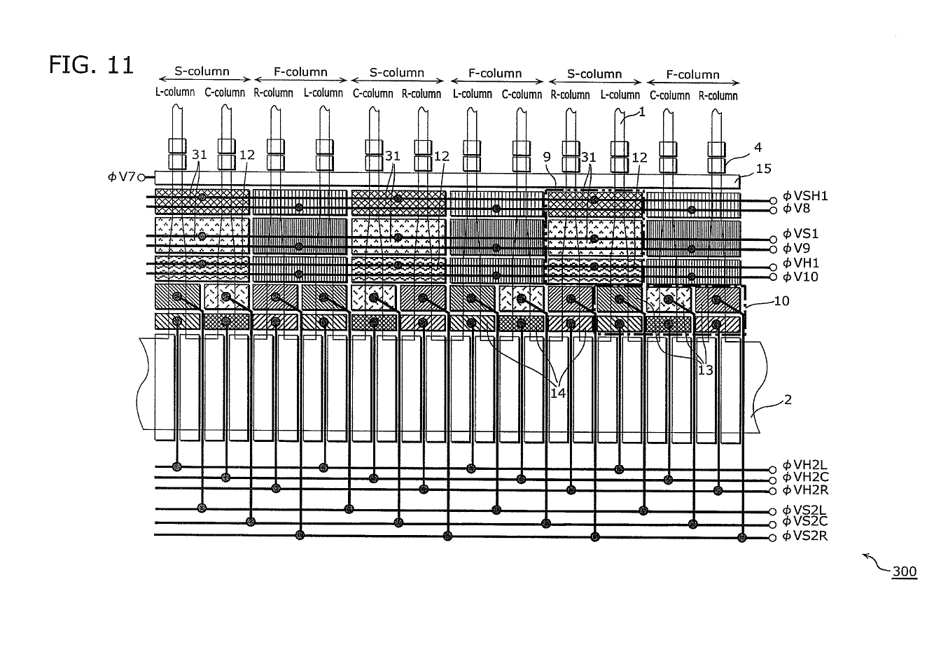

FIG. 11 is a layout diagram showing the configuration of the solid-state imaging device according to the second embodiment of the present invention.

A solid-state imaging device 300 shown in the figure has approximately the same configuration as the solid-state imaging device 200 shown in FIG. 1 but is different in that, in the vertical transfer units 1 under first signal charge accumulation electrodes 31, the width of the vertical transfer units 1 is increased, and the length of the first signal charge accumulation electrodes 31 is increased in the signal charge transfer direction.

In the solid-state imaging device 200 according to the first embodiment, the amount of saturated signal charge in the first signal charge accumulating electrodes 11 decreases in the case of driving when the signal charge accumulating electrode for forming a potential well in the first transfer control unit 9 is one electrode.

However, with the solid-state imaging device 300, in the vertical transfer units 1 under first signal charge accumulation electrodes 31, the width of the vertical transfer units 1 is increased, and the length of the first signal charge accumulation electrodes 31 is increased in the signal charge transfer direction. With this, the following advantageous effect can be obtained.

In a mode with a small number of pixels to be added (the horizontal two-pixel addition mode in the present embodiment), the saturated output after two-pixel addition decreases compared to that in three-pixel addition, and thus it is preferable that the amount of saturated signal charge in the vertical transfer units 1 is larger for the first signal charge accumulation electrodes 31 than the second signal charge accumulation electrodes 13. For example, in the case of securing a saturated output of 1000 mV after addition, although the signal voltage per column of the vertical transfer units 1 is 333 mV, this becomes 500 mV in horizontal two-pixel addition which is 1.5 times as much. With the solid-state imaging device 300 according to the present embodiment, even when the same transfer electric field as the first embodiment is secured in the first signal charge accumulation electrodes 31, a large amount of saturated signal charge is generated in the first signal charge accumulation electrodes 31 compared to the amount of saturated signal charge in the first signal charge accumulation electrodes 11. In addition, as shown in FIG. 11, by increasing the length of the first signal charge accumulation electrodes 31, there is the advantage of making it easy to secure margins between wires located in the horizontal direction.

In this manner, compared to the solid-state imaging device 200 according to the first embodiment, with the solid-state imaging device 300 according to the present embodiment, the amount of saturated signal charge that can be accumulated in the first transfer control units 9 can be increased.

### Third Embodiment

Furthermore, a solid-state imaging device according to the present invention includes: a plurality of photoelectric conversion units arranged in rows and columns and configured to generate signal charges; a plurality of vertical transfer units each of which is provided to a corresponding one of the columns of the photoelectric conversion units and configured to transfer the generated signal charges in a vertical direction; a horizontal transfer unit configured to transfer the signal charges in a horizontal direction; a selective transfer unit provided in a stage after the vertical transfer units and configured to selectively hold and transfer signal charges; and a final vertical transfer unit provided between the selective transfer unit and the horizontal transfer unit, wherein the selective transfer unit includes signal charge accumulating electrodes to which a first voltage is applied when the transfer of the signal charges is to be stopped, and transfer inhibiting electrodes to which a second voltage of a level lower than the first voltage is applied, the number of the signal charge accumulating electrodes is one per column, the transfer inhibiting electrodes are provided on a side of the selective transfer unit closer to the final vertical transfer unit, the final vertical transfer unit includes a final vertical electrode provided adjacent to a corresponding one of the transfer inhibiting electrodes, and a length of the final vertical electrode in a signal charge transfer direction is shorter than a length of the transfer inhibiting electrodes in the signal charge transfer direction.

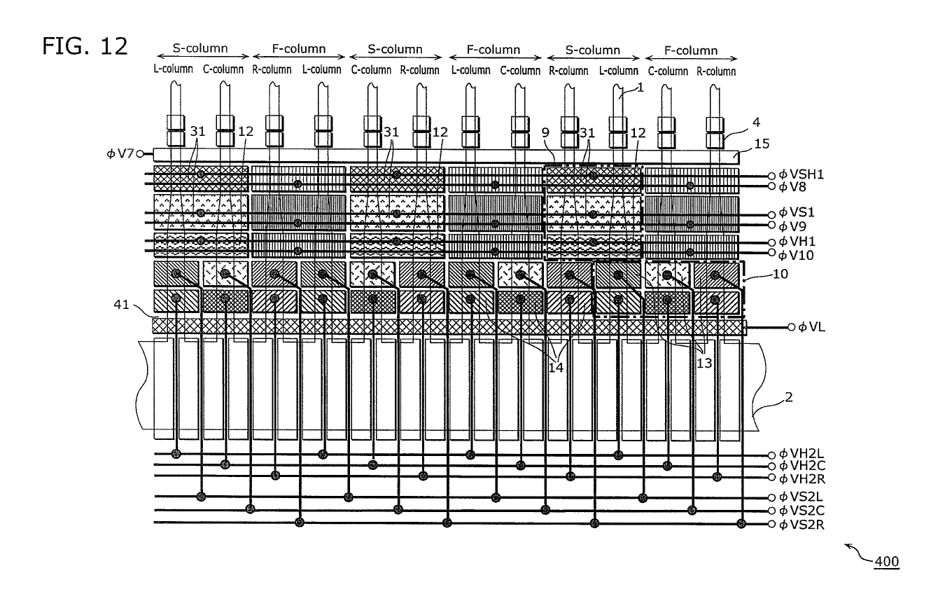

FIG. 12 is a layout diagram showing the configuration of the solid-state imaging device according to the third embodiment of the present invention.

A solid-state imaging device 400 shown in the figure is approximately the same as the solid-state imaging device 300 in the second embodiment and is different in further including a final vertical electrode 41.

Furthermore, the second transfer control units 10 correspond to the selective transfer unit in the present invention, the second signal charge accumulating electrodes 13 correspond to the signal charge accumulating electrodes in the present invention, and the second transfer inhibiting electrodes 14 correspond to the transfer inhibiting electrodes in the present invention.

Compared to the first and second embodiments, in the present embodiment, the final vertical electrode 41 is independently provided, and the length of the second transfer inhibiting electrodes 14 is increased in the signal charge transfer direction.

In the solid-state imaging devices 200 and 300 according to the first and second embodiments, respectively, the second transfer inhibiting electrodes 14 serve as a final vertical electrode. However, considering Fixed Pattern Noise (FPN) generated by defective transfer from the vertical transfer units 1 to the horizontal transfer unit 2, in the case where the second transfer inhibiting electrodes 14 are designed to be short, the potential of the second transfer inhibiting electrodes 14 is modulated and becomes high at the timing at which the potential of the horizontal transfer electrode 2 assumes the high level and the potential of the respective second signal charge accumulating electrodes 13 assumes the middle level, and thus there is the problem that the amount of saturated signal charge of the second signal charge accumulating electrodes 13 decreases. In order to solve this decrease in the amount of saturated signal charge, the length of the second signal accumulating electrodes 13 can be increased to secure the amount of saturated signal charge. However, in this case, fringe electric field decreases when the length of the electrodes increases, and thus transfer efficiency deterioration tends to occur.

In the solid-state imaging device 400 according to the present embodiment, by providing the final vertical electrode 41 which is short in length, the length of the second transfer inhibiting electrodes 14 can be increased up to a point where modulation of the respective second transfer inhibiting electrodes 14 is suppressed when the electrodes adjacent to the respective second transfer inhibiting electrodes 14 in the vertical direction assume the middle level. Therefore, by suppressing the rise of potential of the second transfer inhibiting electrodes 14 in the case where low level voltage is applied to the second transfer inhibiting electrodes 14, the amount of saturated signal charge of the second signal charge accumulating electrodes 13 can be increased compared to those in the first and second embodiment.

Specifically, the length of the second transfer inhibiting electrodes 14 in the signal charge transfer direction is made equal to or greater than the length of the final vertical electrode 41 in the signal charge transfer direction. Stated differently, the final vertical electrode 41 is formed so that its length in the signal charge transfer direction is shorter than the length of the second transfer inhibiting electrodes 14 in the signal charge transfer direction. With this, the amount of saturated signal charge of the second signal charge accumulating electrodes 13 can be increased.

Although it is also possible to connect the final vertical electrode 41 to the vertical transfer electrodes 4 of the pixel repeating portion 5 that are above the vertical transfer units 1, using wires inside the solid-state imaging device so as to share transfer pulses, the load increases and the fall of the transfer pulses becomes slow, and thus, it is preferable to have them as independent electrodes with transfer pulses being applied from the outside.

Although embodiments and modifications of the present invention have been described thus far, the present invention is not limited to such embodiments and modifications. Various modifications to the above-described embodiments and modifications or forms constructed by combining constituent elements of different embodiments and modifications that may be conceived by a person of ordinary skill in the art which do not depart from the essence of the present invention are intended to be within the scope of the present invention.

For example, although a solid-state imaging apparatus that combines horizontal two-pixel mixing and horizontal three-pixel mixing is described in the above-described embodiments, the number of pixels on which pixel mixing is performed is not limited to such. For example, it is also acceptable to have a solid-stage imaging device that combines horizontal four-pixel mixing and horizontal six-pixel mixing. Furthermore, the present invention may be implemented as a camera including the above-described solid-state imaging device.

### INDUSTRIAL APPLICABILITY

The solid-state imaging device according to the present invention allows for plural output modes which add up different numbers of signal charges of horizontally-adjacent same-color pixels, and can implement both a high-resolution, high-high sensitivity mode suitable for high-speed continuous shooting, and a high-speed, high-sensitivity mode suitable for video output, and is thus particularly useful as a solid-state imaging device for digital still cameras.

What is claimed is:

1. A solid-state imaging device comprising:
a plurality of photoelectric conversion units arranged in rows and columns and configured to generate signal charges;
a plurality of vertical transfer units each of which is provided to a corresponding one of the columns of said photoelectric conversion units and configured to transfer the generated signal charges in a vertical direction;
a horizontal transfer unit configured to transfer the signal charges in a horizontal direction; and
a first transfer unit and a second transfer unit which are provided between said plurality of vertical transfer units and said horizontal transfer unit,
wherein said first transfer unit is configured to selectively hold and transfer the signal charges from said vertical transfer units to said second transfer unit so as to mix signal charges of m of said photoelectric conversion units that are of same color and nearest to each other in the horizontal direction, m being an integer equal to or greater than two, and
said second transfer unit is configured to selectively hold and transfer signal charges from said first transfer unit to said horizontal transfer unit so as to mix signal charges of n of said photoelectric conversion units that are of same color and nearest to each other in the horizontal direction, n being an integer greater than m.

2. The solid-state imaging device according to claim 1,
wherein m is an even number and n is an odd number equal to or greater than 3.

3. The solid-state imaging device according to claim 2,
wherein m is 2 and n is 3.

4. The solid-state imaging device according to claim 1,
wherein each of said vertical transfer units includes:
a vertical transfer channel provided to the corresponding one of the columns; and
a plurality of vertical transfer electrodes arranged repeatedly, in predetermined sets, above said vertical transfer channel,
said first transfer unit includes:
a plurality of first transfer channels each of which is formed in the corresponding one of the columns to be continuous with a corresponding one of said vertical transfer channels; and
a plurality of first transfer electrodes formed above each of said first transfer channels and arranged in a row direction and a column direction,
each of said first transfer electrodes has a width spanning at least two columns of said first transfer channels,
said second transfer unit includes:
a plurality of second transfer channels each of which is formed so as to continue from a corresponding one of said first transfer channels in the corresponding one of the columns; and
a plurality of second transfer electrodes formed above each of said second transfer channels, and arranged in the row direction and the column direction, and
each of said second transfer electrodes has a width spanning one column of said second transfer channels.

5. The solid-state imaging device according to claim 4,
wherein said first transfer unit includes a plurality of first transfer control units arranged in the row direction, and
each of said first transfer control units includes at least three of said first transfer electrodes arranged in the column direction, and is controlled according to a transfer pulse that is different from a transfer pulse applied to an adjacent one of said first transfer control units.

6. The solid-state imaging device according to claim 5,
wherein said second transfer unit includes a plurality of second transfer control units arranged in the row direction, and
each of said second transfer control units includes at least two of said second transfer electrodes arranged in the column direction, and
at least two out of three of said second transfer control units arranged consecutively in the row direction are controlled according to a pulse signal that is different from a drive pulse signal applied to said vertical transfer units.

7. The solid-state imaging device according to claim 6,
wherein said first and second transfer control units corresponding to twelve consecutive columns make up one signal unit, and
respective signal units are controlled according to a same group of control pulse signals.

8. The solid-state imaging device according to claim 4,
wherein a width of said first transfer channels is greater than a width of said vertical transfer channels.

9. The solid-state imaging device according to claim 8,
wherein the width of each of said first transfer channels gradually increases between a corresponding one of said vertical transfer units and one of said first transfer electrodes closest to said vertical transfer unit, the width increasing towards said first transfer electrode.

10. The solid-state imaging device according to claim 4,
wherein said plurality of first transfer electrodes included in said first transfer unit includes, for each of the columns, one electrode which selectively accumulates signal charges, and
said plurality of second transfer electrodes included in said second transfer unit includes, for each of the columns, one electrode which selectively accumulates signal charges.

11. The solid-state imaging device according to claim 4, further comprising
an intermediate electrode provided between said vertical transfer units and corresponding ones of said first transfer electrodes closest to said vertical transfer unit, said intermediate electrode being provided above a connection between corresponding ones of said vertical transfer channels and said first transfer channels,
wherein at least one of a width and a length of said intermediate electrode is greater than at least one of a width and a length of said vertical transfer electrodes.

12. The solid-state imaging device according to claim 4,
wherein the number of said first transfer electrodes arranged in the column direction in said first transfer unit is different from the number of said second electrodes arranged in the column direction in said second transfer unit.

13. The solid-state imaging device according to claim 4,
wherein said first transfer electrodes and said second transfer electrodes are formed in a single layer without overlapping each other.

14. A solid-state imaging device comprising:
a plurality of photoelectric conversion units arranged in rows and columns and configured to generate signal charges;
a plurality of vertical transfer units each of which is provided to a corresponding one of the columns of said photoelectric conversion units and configured to transfer the generated signal charges in a vertical direction;
a horizontal transfer unit configured to transfer the signal charges in a horizontal direction;
a selective transfer unit provided in a stage after said vertical transfer units and configured to selectively hold and transfer signal charges; and
a final vertical transfer unit provided between said selective transfer unit and said horizontal transfer unit,
wherein said selective transfer unit includes signal charge accumulating electrodes to which a first voltage is applied when the transfer of the signal charges is to be stopped, and transfer inhibiting electrodes to which a second voltage of a level lower than the first voltage is applied,
the number of said signal charge accumulating electrodes is one per column,
said transfer inhibiting electrodes are provided on a side of said selective transfer unit closer to said final vertical transfer unit,
said final vertical transfer unit includes a final vertical electrode provided adjacent to a corresponding one of said transfer inhibiting electrodes, and
a length of said final vertical electrode in a signal charge transfer direction is shorter than a length of said transfer inhibiting electrodes in the signal charge transfer direction.

15. The solid-state imaging device according to claim 14,
wherein a transfer pulse signal is applied to said final vertical electrode independently of an electrode in a stage ahead of said final vertical electrode.

16. The solid-state imaging device according to claim 14,
wherein said signal charge accumulating electrodes, said transfer inhibiting electrodes, and said final vertical electrode are formed in a single layer without overlapping each other.

17. A camera comprising the solid-state imaging device according to claim 1.

18. A camera comprising the solid-state imaging device according to claim 14.
